(19) United States
(12) Patent Application Publication
(10) Pub. No.: US 2021/0318574 A1
(43) Pub. Date: Oct. 14, 2021

(54) OPPOSITE SUBSTRATE AND METHOD FOR MANUFACTURING THE SAME, LIQUID CRYSTAL PANEL AND 3D PRINTING APPARATUS

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Mingyang LV, Beijing (CN); Yanchen LI, Beijing (CN); Huishun CHEN, Beijing (CN); Jian WANG, Beijing (CN); Yue LI, Beijing (CN); Xiaohui LV, Beijing (CN)

(21) Appl. No.: 17/262,861

(22) PCT Filed: May 26, 2020
(86) PCT No.: PCT/CN2020/092269

§ 371 Date: Jan. 25, 2021

(30) Foreign Application Priority Data
May 31, 2019 (CN) 201910469968.1

(51) Int. Cl. G02F 1/1335; G02F 1/137; B29C 64/20

(52) U.S. Cl. CPC G02F 1/133512; B33Y 30/00; B29C 64/20; G02F 1/13731

(57) ABSTRACT

An opposite substrate is provided. The opposite substrate includes a base substrate, a black matrix, and a phase shift film. The black matrix is disposed on a side of the base substrate, the black matrix defines a plurality of opening regions. The phase shift film is disposed on the side of the base substrate, the phase shift film includes at least one first portion, and at least one of the opening regions is provided with a first portion therein. The first portion is frame-shaped, and an outer border of the first portion coincides with a border of an opening region. The phase shift film is configured to reverse a phase of a light wave passing through itself.

### CROSS-REFERENCE TO RELATED APPLICATIONS

This application is a national phase entry under 35 USC 371 of International Patent Application No. PCT/CN2020/092269, filed on May 26, 2020, which claims priority to Chinese Patent Application No. 201910469968.1, filed on May 31, 2019, which are incorporated herein by reference in their entirety.

### TECHNICAL FIELD

The present disclosure relates to the field of 3D printing technologies, and in particular, to an opposite substrate and a method for manufacturing the same, a liquid crystal panel, and a 3D printing apparatus.

### BACKGROUND

Since the advent of 3D printing technology, it has broad application prospects in the fields of healthcare, manufacturing industry, military affairs, etc.

According to materials currently used in 3D printing, molding technologies can be divided into two types. One is a molding technology that uses laser beams to melt and sinter with various powders or thin films as raw materials, and the other is a molding technology that, with liquid resin as a raw material, performs light curing on the liquid resin by controlling the luminous flux of ultraviolet light.

### SUMMARY

An opposite substrate is provided. The opposite substrate includes a base substrate, a black matrix, and a phase shift film. The black matrix is disposed on a side of the base substrate, the black matrix defines a plurality of opening regions. The phase shift film is disposed on the side of the base substrate; the phase shift film includes at least one first portion, and at least one of the opening regions is provided with a first portion therein. The first portion is frame-shaped, and an outer border of the first portion coincides with a border of an opening region. The phase shift film is configured to reverse a phase of a light wave passing through itself.

In some embodiments, a distance between an outer side and its opposite inner side of the first portion of the phase shift film in a direction perpendicular to the outer side is equal to a distance between another outer side and its opposite inner side in a direction perpendicular to the other outer side.

In some embodiments, a distance between the outer side and its opposite inner side of the first portion of the phase shift film in the direction perpendicular to the outer side is within a range of 0.4 μm to 0.5 μm.

In some embodiments, the phase shift film further includes a second portion. The second portion covers a side of the black matrix away from the base substrate; the second portion and the first portion are continuous and are an integrative structure; and an orthographic projection of the second portion on the base substrate and an orthographic projection of the black matrix on the base substrate at least partially overlap.

In some embodiments, first portions of the phase shift film located in two adjacent opening regions and the second portion of the phase shift film covering a portion of the black matrix between the two adjacent opening regions are continuous and are an integrative structure.

In some embodiments, a material of the black matrix includes chromium.

In some embodiments, the opposite substrate further includes an encapsulation layer, and the encapsulation layer is disposed on a side of the black matrix and the phase shift film away from the base substrate.

In some embodiments, a material of the encapsulation layer includes transparent resin.

In another aspect, a liquid crystal panel is provided. The liquid crystal panel includes an array substrate, an opposite substrate, and a liquid crystal layer. The opposite substrate is opposite to the array substrate; the opposite substrate is the opposite substrate as described above, and an opening region in the opposite substrate is directly opposite to a sub-pixel of the liquid crystal panel. The liquid crystal layer is disposed between the array substrate and the opposite substrate.

In some embodiments, the liquid crystal panel further includes: a first polarizer disposed on a side of the array substrate away from the opposite substrate, and a second polarizer disposed on a side of the opposite substrate away from the array substrate.

In yet another aspect, a 3D printing apparatus is provided. The 3D printing apparatus includes a light source and the liquid crystal panel as described above. The light source is disposed at a side of the array substrate of the liquid crystal panel away from the opposite substrate. The liquid crystal panel is configured to control a luminous flux of light emitted by the light source according to a cross-sectional pattern of an object to be printed, so as to display the cross-sectional pattern of the object to be printed.

In some embodiments, the light emitted by the light source is ultraviolet light with a wavelength in a range of 300 nm to 400 nm.

In yet another aspect, a method for manufacturing the opposite substrate is provided. The method includes: providing the base substrate; forming the black matrix on the side of the base substrate, the black matrix defining the plurality of opening regions; forming the phase shift film on the side of the base substrate, the phase shift film including the at least one first portion, and the at least one of the opening regions is provided with the first portion therein; the first portion being frame-shaped, and the outer border of the first portion coinciding with the border of the opening region; the phase shift film being configured to reverse the phase of the light wave passing through itself.

In some embodiments, a distance between an outer side and its opposite inner side of the first portion of the phase shift film in a direction perpendicular to the inner side is equal to a distance between another outer side and its opposite inner side in a direction perpendicular to the inner side.

In some embodiments, a distance between an outer side and its opposite inner side of the first portion of the phase shift film in a direction perpendicular to the inner side is within a range of 0.4 μm to 0.5 μm.

In some embodiments, forming the phase shift film on the side of the base substrate further includes: forming the phase shift film including a second portion. The second portion covers a side of the black matrix away from the base substrate; the second portion and the first portion are continuous and are an integrative structure; and an orthographic projection of the second portion on the base substrate and an orthographic projection of the black matrix on the base substrate at least partially overlap.

In some embodiments, first portions of the phase shift film located in two adjacent opening regions and a portion of the second portion of the phase shift film covering a portion of the black matrix between the two adjacent opening regions are continuous and are an integrative structure.

In some embodiments, the method further comprising: forming an encapsulation layer on a side of the black matrix and the phase shift film away from the base substrate.

### BRIEF DESCRIPTION OF THE DRAWINGS

In order to describe technical solutions in the present disclosure more clearly, accompanying drawings to be used in some embodiments of the present disclosure will be introduced below briefly. Obviously, the accompanying drawings to be described below are merely accompanying drawings of some embodiments of the present disclosure, and other accompanying drawings may be obtained according to these accompanying drawings by a person of ordinary skill in the art. In addition, the accompanying drawings to be described below may be regarded as schematic diagrams, and are not limitations on actual sizes of products, actual processes of methods and actual timings of a signals to which the embodiments of the present disclosure relate.

FIG. 1 is a structural diagram of a 3D printing apparatus, according to some embodiments of the present disclosure;

FIG. 2 is a top view of a liquid crystal panel, according to some embodiments of the present disclosure;

FIG. 3 is a cross-sectional view taken along the section line A-A′ in FIG. 2;

FIG. 4 is a comparative diagram of viewing angles of a 3D printing apparatus before and after a phase shift film is provided on an opposite substrate thereof, according to some embodiments of the present disclosure;

FIG. 5 is an optical path diagram during a 3D printing process in a case where a phase shift film is not provided, according to some embodiments of the present disclosure;

FIG. 6 is an optical path diagram during a 3D printing process in a case where a phase shift film is provided, according to some embodiments of the present disclosure;

FIG. 7 is another cross-sectional view taken along the section line A-A in FIG. 2;

FIG. 8 is yet another cross-sectional view taken along the section line A-A′ in FIG. 2;

FIG. 9A is a top view of an opposite substrate, according to some embodiments of the present disclosure;

FIG. 9B is an enlarged view of the region G in FIG. 9A;

FIG. 9C is a cross-sectional view taken along the section line C-C′ in FIG. 9A;

FIG. 10 is a flow diagram of a method for 3D printing by using a 3D printing apparatus, according to some embodiments of the present disclosure; and

FIG. 11 is a schematic diagram of an object to be printed, according to some embodiments of the present disclosure.

### DETAILED DESCRIPTION

Technical solutions in some embodiments of the present disclosure will be described below clearly and completely in combination with the accompanying drawings. Obviously, the described embodiments are merely some but not all embodiments of the present disclosure. All other embodiments obtained on the basis of the embodiments provided by the present disclosure by a person of ordinary skill in the art shall be included in the protection scope of the present disclosure.

Unless the context requires otherwise, throughout the description and claims, the term “comprise” and other forms thereof such as the third-person singular form “comprises” and the present participle form “comprising” are construed as open and inclusive, i.e., “including, but not limited to”. In the description of the specification, terms such as “one embodiment”, “some embodiments”, “exemplary embodiments”, “example”, “specific example”, or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, terms such as “first” and “second” are used for descriptive purposes only, and are not to be construed as indicating or implying the relative importance or implicitly indicating the number of indicated technical features. Thus, features defined as “first” and “second” may explicitly or implicitly include one or more of the features. In the description of the embodiments of the present disclosure, the term “a plurality of” and “the plurality of” each mean two or more unless otherwise specified.

In the description of some embodiments, the terms such as “coupled” and “connected” and their extensions may be used. For example, the term “connected” may be used in the description of some embodiments to indicate that two or more elements are in direct physical or electrical contact with each other. For another example, the term “coupled” may be used in the description of some embodiments to indicate that two or more components are in direct physical or electrical contact. However, the term “coupled” or “communicatively coupled” may also mean that two or more elements are not in direct contact with each other, but still cooperate or interact with each other. The embodiments disclosed herein are not necessarily limited to the content herein.

The use of “applicable to” or “configured to” means an open and inclusive expression, which does not exclude apparatuses that are applicable to or configured to perform additional tasks or steps.

Exemplary embodiments are described herein with reference to cross-sectional views and/or plan views as idealized exemplary drawings. In the accompanying drawings, thicknesses of layers and regions are exaggerated for clarity. Thus, variations in shapes relative to the accompanying drawings due to, for example, manufacturing techniques and/or tolerances may be envisaged. Therefore, the exemplary embodiments should not be construed as being limited to the shapes of regions shown herein, but include deviations in shape due to, for example, manufacturing. For example, an etching region shown as a rectangle usually has a feature of being curved. Therefore, the regions shown in the accompanying drawings are schematic in nature and their shapes are not intended to show actual shapes of the regions in an apparatus and are not intended to limit the scope of the exemplary embodiments.

In the description of the present disclosure, it will be understood that orientations or positional relationships indicated by terms “center”, “upper”, “lower”, “front”, “rear”, “left”, “right”, “vertical”, “horizontal”, “top”, “bottom”, “inner”, “outer”, etc. are based on orientations or positional relationships shown in the accompanying drawings, which is merely to facilitate and simplify the description of the present disclosure, and is not to indicate or imply that the referred devices or elements must have a particular orientation, or must be constructed or operated in a particular orientation. Therefore, they should not be construed as limitations to the present disclosure.

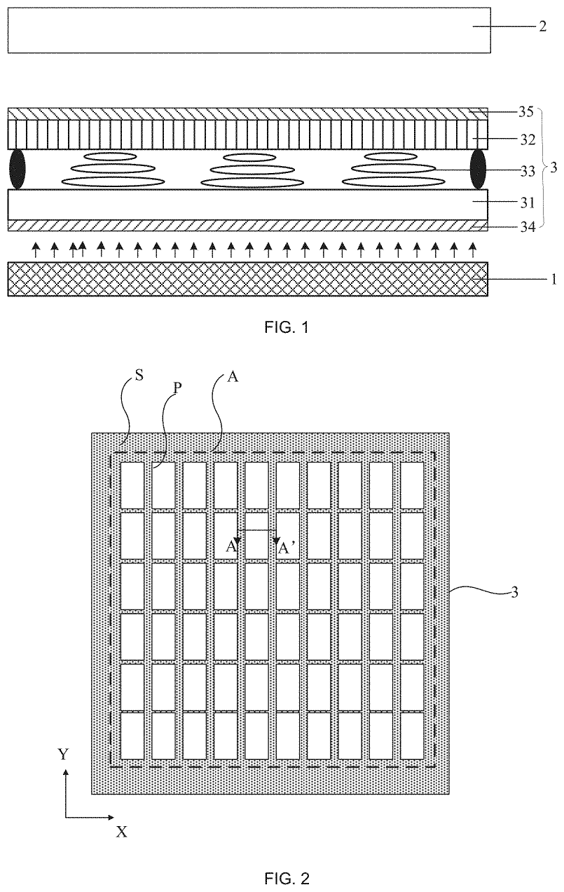

Some embodiments of the present disclosure provide a 3D printing apparatus. Referring to FIG. 1, the 3D printing apparatus includes a light source 1 and a liquid crystal panel 3. The liquid crystal panel 3 includes an array substrate 31 and an opposite substrate 32 that are opposite. The light source 1 is disposed at a side of the array substrate 31 of the liquid crystal panel 3 away from the opposite substrate 32. As shown in FIG. 11, the liquid crystal panel 3 is configured to control a luminous flux of light emitted by the light source 1 according to a cross-sectional pattern 400 of an object to be printed 40, so as to display the cross-sectional pattern of the object to be printed.

In some examples, a printing material used in the 3D printing apparatus is a liquid resin 2. As shown in FIG. 1, the liquid resin 2 is disposed at a side of the opposite substrate 32 of the liquid crystal panel 3 away from the array substrate 31. The liquid resin 2 can be cured under the action of light, so that after passing through the liquid crystal panel 3, the light emitted by the light source reaches the liquid resin according to a shape of the cross-sectional pattern of the object to be printed. As a result, a portion of the liquid resin receiving light is cured, whereas a portion not receiving light is not cured, remains liquid and is removed. Thus, a layer of pattern of a 3D model is formed. After irradiation, curing and stacking layer by layer, the 3D model is finally formed. A shape of the 3D model is consistent with a shape of the object to be printed.

Optionally, the light source 1 is an ultraviolet lamp, and the light emitted by the light source is ultraviolet light with a wavelength in a range of 300 nm to 400 nm. Correspondingly, the liquid resin 2 may be a resin material that can be cured under the irradiation of ultraviolet light.

As shown in FIG. 1, the liquid crystal panel 3 includes the array substrate 31, the opposite substrate 32, and a liquid crystal layer 33 disposed between the array substrate 31 and the opposite substrate 32. The array substrate 31 and the opposite substrate 32 are assembled together with a sealant, so that the liquid crystal layer 33 is confined within a region enclosed by the sealant.

In some embodiments, as shown in FIG. 1, the liquid crystal pan& 3 may further include a first polarizer 34 disposed on a side of the array substrate 31 away from the opposite substrate 32, and a second polarizer 35 disposed on a side of the opposite substrate 32 away from the array substrate.

By providing the first polarizer 34 and the second polarizer 35, and making them cooperate with the liquid crystal layer, liquid crystal molecules in the liquid crystal layer 33 may rotate under the action of an electric field to change a traveling direction of the light, so that it is possible to make the light emitted by the light source 1 have a set luminous flux after passing through the liquid crystal panel 3 by controlling the electric field, thereby realizing the light curing to the liquid resin 2.

As shown in FIG. 2, the liquid crystal panel 3 is divided into a display area A and a peripheral region S. The display area A is configured to realize display, and the peripheral region S is configured for wiring. In addition, a gate driver circuit may also be provided in the peripheral region S, that is, the gate driver circuit is disposed on the array substrate 31 in a form of gate driver on array (GOA) FIG. 2 shows an example in which the peripheral region S surrounds the display area A.

The display area A is provided with a plurality of sub-pixels P therein. Herein, as shown in FIG. 2, a description is made by taking the plurality of sub-pixels P arranged in a matrix form as an example.

In this case, the sub-pixels P arranged in a row along a horizontal direction X are referred to as sub-pixels in a same row, and the sub-pixels P arranged in a column along a vertical direction Y are referred to as sub-pixels in a same column. The sub-pixels in the same row may be coupled to a gate line, and the sub-pixels in the same column may be coupled to a data line.

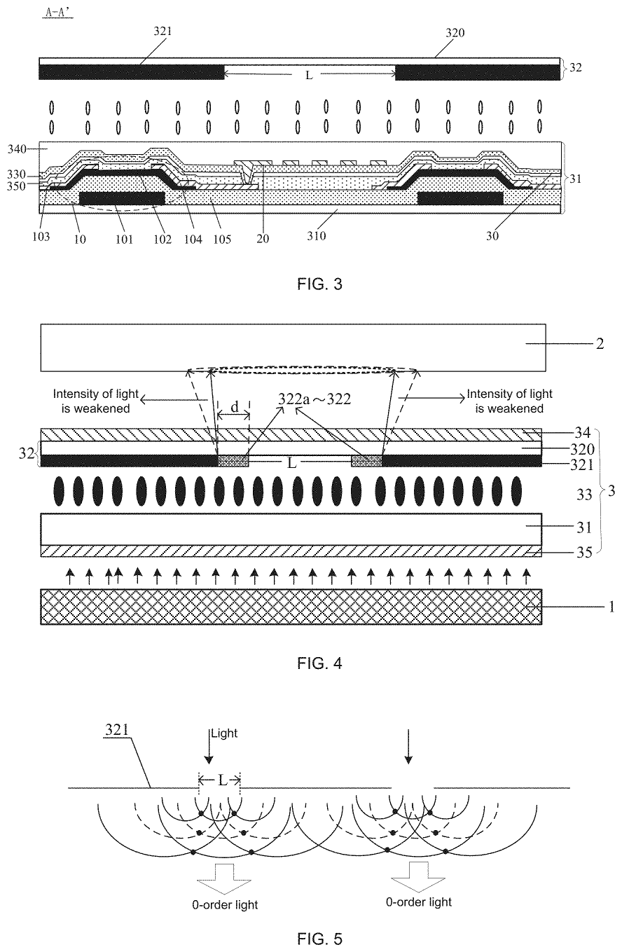

As shown in FIG. 3, the array substrate 31 includes a second base substrate 310, and a plurality of thin-film transistors (TFTs) 10, pixel electrodes 20, common electrode(s) 30, and a plurality of insulating film layers that are disposed on a side of the second base substrate 310. For example, each sub-pixel P is provided with a thin-film transistor 10 and a pixel electrode 20. The thin-film transistor 10 includes an active layer 102, a source 103, a drain 104, a gate 101, and a portion of a gate insulating layer (also called gate insulator, short for GI) 105. FIG. 3 shows an example in which the thin-film transistor 10 is of a bottom gate structure. The gate 101 is disposed at a side of the active layer 102 proximate to the second base substrate 310, the source 103 and the drain 104 are coupled to the active layer 102, and the pixel electrode 20 is coupled to the drain 104 of the thin-film transistor 10. The thin-film transistor 10 may also be of a top gate structure, which is not limited in the present disclosure.

In some embodiments, the array substrate 31 further includes the common electrode(s) 30 disposed at the side of the second base substrate 310. For example, the pixel electrodes 20 and common electrodes 30 may be disposed in a same layer. In this case, the pixel electrode 20 and the common electrode 30 are both comb structures including a plurality of strip-shaped sub-electrodes. For example, as shown in FIG. 3, the pixel electrodes 20 and the common electrode 30 may also be disposed in different layers. In this case, the pixel electrode 20 has a comb structure including a plurality of strip-shaped sub-electrodes, and the common electrode 30 has a plate shape as a whole. For example, the array substrate 31 further includes a first insulating layer 350, a second insulating layer 330 and a third insulating layer 340. The first insulating layer 350 is disposed on a side of the source 103 and the drain 104 of the thin-film transistor 10 away from the second base substrate 310, the common electrode 30 is disposed on a side of the first insulating layer 350 away from the second base substrate 310, the second insulating layer 330 is disposed on a side of the common electrode 30 away from the second base substrate 310, the pixel electrode 20 is disposed on a side of the second insulating layer 330 away from the second base substrate 310, and the third insulating layer 340 is disposed on a side of the pixel electrode 20 away from the second base substrate 310.

In some other embodiments, the array substrate 31 further includes gate lines and data lines, the gate 101 of the thin-film transistor 10 is electrically connected to a gate line, and the source 103 of the thin-film transistor 10 is electrically connected to a data line. The thin-film transistor 10 in the array substrate 31 is configured to control whether to provide a signal to the pixel electrode 20. When the gate line transmits a signal, the thin-film transistor 10 coupled to the gate line is turned on, so that the signal transmitted by the data line is provided to the pixel electrode 20 through the turned-on thin-film transistor 10. As a result, an electric field is formed between the pixel electrode 20 and the common electrode 30 to drive the liquid crystal molecules to deflect.

As shown in FIG. 3, the opposite substrate 32 includes a base substrate 320 (which may be referred to as a first base substrate 320), and a black matrix 321 disposed on a side of the base substrate 320. The black matrix 321 defines a plurality of opening regions L, and an opening region L is directly opposite to a sub-pixel P of the liquid crystal panel 3.

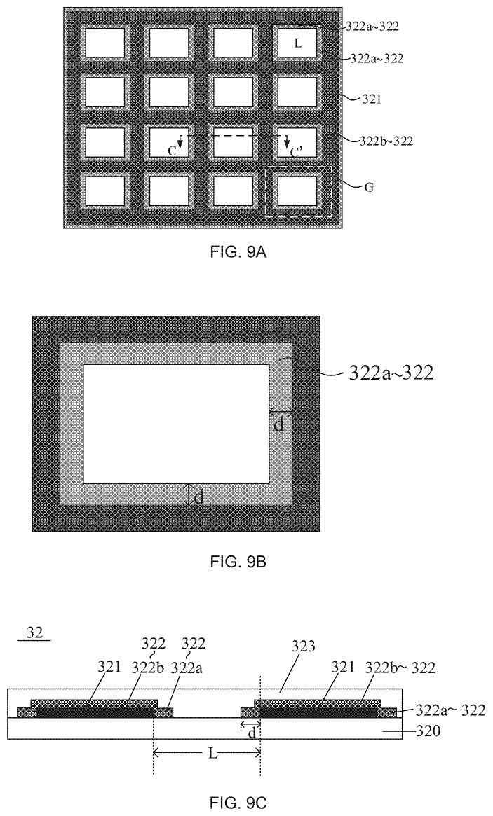

For example, as shown in FIGS. 3 and 9A, the black matrix 321 is grid-like and has a plurality of openings, thereby defining the plurality of opening regions L. The black matrix 321 is configured to shield the thin-film transistors 10 and a plurality of signal lines in the array substrate 31, and the light can exit by passing through the plurality of openings of the black matrix 321.

When the 3D printing is performed, the liquid crystal panel 3 may subdivide the light emitted by the light source 1 into denser units of light, that is, each unit of light is the light with a pixel size. In addition, the liquid crystals in the liquid crystal panel 3 have a function of light valve, so as to control the luminous flux, so that the intensity of each unit of light may be adjusted quickly and accurately, and thus the liquid crystal panel 3 may display the cross-sectional pattern of the object to be printed. As a result, after passing through the liquid crystal panel 3, the light emitted by the light source reaches the liquid resin according to the shape of the cross-sectional pattern of the object to be printed, so that a portion of the liquid resin receiving light is cured, and a portion not receiving light is not cured, remains liquid and is removed. Thus, a layer of pattern of the 3D model is formed. After radiation, curing and stacking layer by layer, the 3D model is formed finally. The shape of the 3D model is consistent with the shape of the object to be printed.

In this process, since the liquid crystal panel 3 can subdivide the light emitted by the light source 1 into denser units of light, and the intensity of each unit of light may be quickly and accurately adjusted by the light valve function of the liquid crystals, so that a position on the liquid resin where photocuring is performed may be controlled accurately. As a result, the 3D model finally obtained has a high degree of consistency with the object to be printed, and thus the 3D printing apparatus provided by embodiments of the present disclosure has relatively high printing accuracy.

According to control principle of the luminous flux of the liquid crystal panel 3, as shown in FIG. 4, due to the presence of liquid crystal molecules, the light is scattered after passing through the liquid crystal molecules, and exits at an edge of the opening region L, thereby forming a larger viewing angle. That is, after passing through the liquid crystal molecules, the light exits from positions where the plurality of openings of the opposite substrate 32 are located. As a result of scattering, a range of the exiting light is larger than a range defined by the opening. In this way, a region of the liquid resin 2 that should have been shielded by the black matrix 321 is also irradiated by the light and cured, resulting in a deviation in the shape of the obtained 3D model, which is not conducive to the improvement of the accuracy of the 3D printing. It can be seen that for the 3D printing technology, the narrower the viewing angle of the liquid crystal panel 3, the higher the printing accuracy. The viewing angle of the liquid crystal panel 3 is related to the intensity of the light exiting from the plurality of openings of the black matrix, so that the intensity of each unit of light will be accurately controlled.

As shown in FIG. 5, the light emitted by the light source 1 travels forward in a form of sine waves, the wave crests of lights with the same phase are superposed at a point position near the opening region L (e.g., the wave crest is represented by a wave of a solid line in FIG. 5, and the superposition between wave crests is represented by a black dot in FIG. 5), and the wave troughs thereof are superposed at a point position near the opening region L (e.g., the wave trough is represented by a wave of a dotted line in FIG. 5, and the superposition between wave troughs is represented by the black dot in FIG. 5), so as to form 0-order light. The 0-order light increases an amplitude of the light wave at the edge of the opening region L which should have been shielded by the black matrix 321, and increases the intensity of light, so that the light exiting via each opening region L is diffused to the periphery to form a sector, and form a relatively large viewing angle. As a result, large spots are formed when the light reaches the liquid resin 2, and the region of the liquid resin that should have been shielded by the black matrix 321 is also irradiated by the light and cured, which is not conducive to the improvement of resolution and the accuracy of the 3D printing.

Based on this, in the embodiments of the present disclosure, as shown in FIGS. 4 and 9A, the opposite substrate 32 further includes a phase shift film 322 disposed on a side of the base substrate 320. The phase shift film 322 includes at least one first portion 322a, and at least one opening region L is provided with a first portion 322a therein. The first portion 322a is frame-shaped, and an outer border of the first portion 322a coincides with or roughly coincides with a border of the opening region L. The phase shift film 322 is configured to reverse the phase of the light wave passing through itself.

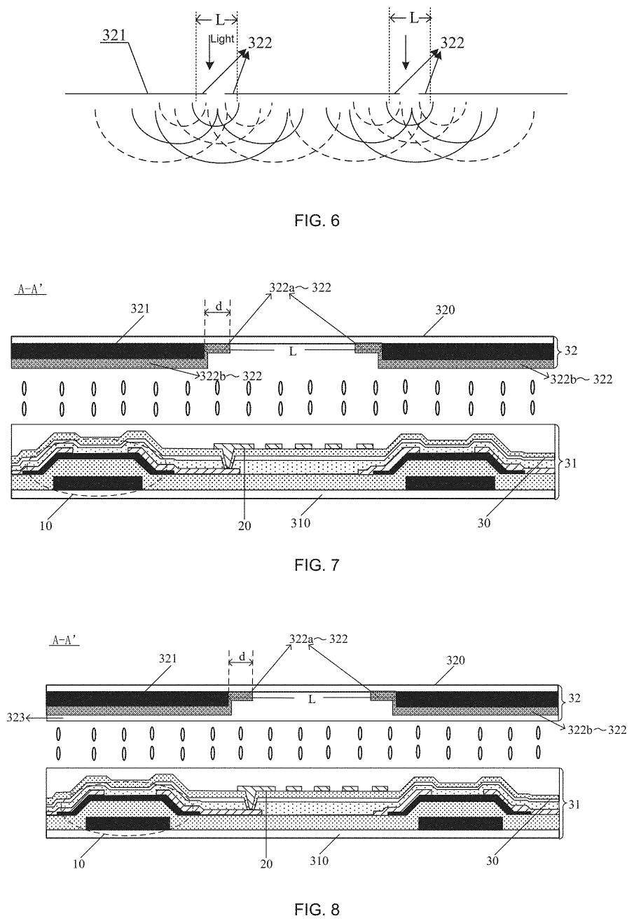

In the embodiments of the present disclosure, as shown in FIGS. 4 and 6, the phase shift film 322 is provided, at least one opening region L is provided with the first portion 322a of the phase shift film therein, the first portion 322a is frame-shaped, and the outer border of the first portion 322a coincides with or roughly coincides with the border of the opening region L. In this way, when the light exits via the opening region L, a portion of the light exits after passing through the first portion 322a of the phase shift film 322, and another portion of the light directly exits without passing through the phase shift film 322. Since the phase shift film 322 can reverse the phase of the light wave passing through itself, during printing, a phase of the portion of the light exiting after passing through the first portion 322a of the phase shift film 322 may be reversed.

For example, referring to FIGS. 5 and 6, after the light of the sine wave with the same phase passes through the phase shift film 322, the phase shift is reversed by 180°. For example, the original wave crests are reversed to wave troughs (e.g., the waves of dotted lines in FIG. 6 are wave troughs). While in a region where the phase shift film 322 is not provided in the opening region L, the light does not undergo the phase reversal effect of the phase shift film 322, and the wave crest remains as the wave crest at the same position. In this way, in an opening region L, destructive interference may occur between the portion of the light exiting after passing through the first portion 322a of the phase shift film 322 and a portion of the light wave beside it that is not shielded by the phase shift film 322. That is, the wave crest (as shown by the wave of solid line in FIG. 6) and the wave trough are superposed, and destructive interference occurs between the two, so that the 0-order light disappears or is greatly weakened. As a result, the light intensity of the 0-order light is weakened, which may greatly weaken the light intensity of the light waves exiting at an edge of the opening region L after being scattered by the liquid crystals (as shown in FIG. 4). It is possible to reduce the viewing angle, make the light more accurately irradiate a specific position of the liquid resin 2, and improve the resolution, thereby improving the accuracy of the 3D printing.

For example, as shown in FIG. 9A, each opening region L is provided with a first portion 322a therein, so that the light intensity of the light waves exiting at an edge of each opening region L may be reduced, and the viewing angle of the liquid crystal panel 3 may be further reduced, thereby further improving the accuracy of the 3D printing.

In some examples, as shown in FIG. 9B, a distance d between an outer side and its opposite inner side of the first portion 322a of the phase shift film 322 in a direction perpendicular to the outer side is equal to a distance d between another outer side and its opposite inner side in a direction perpendicular to the other outer side. For example, a distance between a right outer side and its opposite inner side of the first portion 322a in a direction perpendicular to the right outer side and a distance between a lower outer side and its opposite inner side in a direction perpendicular to the lower outer side are both a first distance d.

This design may make the weakening degree of the light intensity of the light waves exiting at the edges of the opening region L be consistent, so that the viewing angle of the liquid crystal panel 3 may be kept within a reasonable range, thereby further improving the accuracy of the 3D printing.

In some examples, in order to reduce the viewing angle to a suitable range, an area of the first portion 322a of the phase shift film 322 will match an area of the opening region L, and an area of a region of the opening region L that is shielded by the first portion 322a of the phase shift film 322 will be set in an appropriate size. In this way, it is possible to ensure a small viewing angle, improve the printing accuracy, and will not cause great reduction in the intensity of light to affect a light curing effect.

Optionally, as shown in FIG. 4, the distance between the outer side and its opposite inner side of the first portion 322a of the phase shift film 322 in the direction perpendicular to the outer side is within a range of 0.4 μm to 0.5 μm.

A position of the phase shift film 322 is not specifically limited. The phase shift film 322 may be disposed on a side of the base substrate 320 away from the black matrix 321, or may be disposed on a side of the base substrate 320 facing the black matrix 321.

In an optional embodiment of the present disclosure, as shown in FIG. 4, the phase shift film 322 is disposed on the side of the base substrate 320 facing the black matrix 321.

In some embodiments, in order to facilitate the formation of the phase shift film 322 and reduce the difficulty for forming the phase shift film 322, as shown in FIGS. 7 to 9C, the phase shift film 322 further includes a second portion 322b, and the second portion 322b covers a side of the black matrix 321 away from the base substrate 320. The second portion 322b and the first portion 322a are continuous and are an integrative structure. An orthographic projection of the second portion 322b on the base substrate 320 and an orthographic projection of the black matrix 321 on the base substrate 320 at least partially overlap.

In some examples, as shown in FIG. 9C, the first portions 322a of the phase shift film 322 located in two adjacent opening regions L and the second portion 322b of the phase shift film 322 covering a portion of the black matrix 321 between the two adjacent opening regions L are continuous and are an integrative structure.

This design may reduce the difficulty of formation process of the opposite substrate 32. For example, after the black matrix 321 is formed, the phase shift film 322 with an integrative structure can be formed in one-time on the side of the black matrix 321 away from the base substrate 320. In this way, a pattern of the first portions 322a of the phase shift film 322 will not be controlled by a patterning process, so that the outer boarder of the first portion 322a may coincide with or roughly coincide with the border of the opening region L, thereby reducing the process difficulty.

In some examples, the black matrix 321 is made of a material with good light-shielding performance, which is not limited in the present disclosure. For example, the material of the black matrix 321 may include chromium or black ink, in which chromium has an excellent thermal stability and chemical stability, and good light-shielding performance. The thermal stability and the chemical stability of the black matrix 321 may be improved by using chromium as the material of the black matrix 321.

In yet another embodiment of the present disclosure, as shown in FIGS. 8 and 9C, the opposite substrate 32 further includes an encapsulation layer 323, and the encapsulation layer 323 is disposed on a side of the black matrix 321 and the phase shift film 322 away from the base substrate 320. By adding the encapsulation layer 323, the phase shift film 322 and the black matrix 321 may be protected to prevent external impurities from entering.

Optionally, a material of the encapsulation layer 323 may include a transparent resin.

Some embodiments of the present disclosure further provide a method for manufacturing an opposite substrate, and the method includes S1 to S3.

In S1, a base substrate 320 is provided.

In S2, a black matrix 321 is formed on a side of the base substrate 320. The black matrix 321 defines a plurality of opening regions L, and an opening region L corresponds to a sub-pixel of a liquid crystal panel 3.

For example, a black matrix layer is formed on the side of the base substrate 320, the black matrix layer is patterned to remove portions of the black matrix layer located in the opening regions L, so that the black matrix 321 with the plurality of openings are obtained. For example, the black matrix layer may be patterned by using exposure and development processes to form the black matrix 321.

In S3, a phase shift film 322 is formed on a side of the base substrate 320. The phase shift film 322 includes at least one first portion 322a, and at least one opening region L is provided with a first portion 322a therein. The first portion 322a is frame-shaped, and an outer border of the first portion 322a coincides with or roughly coincides with a border of the opening region L. The phase shift film 322 is configured to reverse the phase of the light wave passing through itself.

For example, a first portion of the phase shift film 322 is formed in at least one opening region L on the side of the base substrate 320. For example, a phase shift film layer may be formed on the side of the base substrate 320, and the phase shift film layer is patterned, so that the first portion 322a of the formed phase shift film 322 is frame-shaped, and the outer border of the first portion 322a coincides with or roughly coincides with the border of the opening region L.

In some embodiments, in a case where the phase shift film 322 further includes the second portion 322b, the S3 in the method for manufacturing the opposite substrate 32 includes:

S3, forming the phase shift film 322 on the side of the base substrate 320. The phase shift film 322 includes the at least one first portion 322a and the second portion 322b, and at least one opening region L is provided with the first portion 322a therein. The first portion 322a is frame-shaped, and the outer border of the first portion 322a coincides with or roughly coincides with the border of the opening region L. The second portion 322b covers a side of the black matrix 321 away from the base substrate 320, and the second portion 322b and the first portions 322a are continuous and are an integrative structure. The orthographic projection of the second portion 322b on the base substrate 320 and the orthographic projection of the black matrix 321 on the base substrate 320 at least partially overlap.

For example, the above step includes: forming a phase shift film layer on the side of the black matrix 321 away from the base substrate 320, so that the phase shift film layer covers the black matrix 321 and the opening regions L; patterning the phase shift film layer to remove the portions thereof that are located in central regions of the opening regions L, so that the first portion 322a of the formed phase shift film 322 is frame-shaped, and the outer border of the first portion 322a coincides with or roughly coincides with the border of the opening region L. In addition, the first portions 322a and the second portion 322b included in the formed phase shift film 322 are the integrative structure.

For example, the phase shift film layer may be patterned by using a photolithography process to obtain the phase shift film.

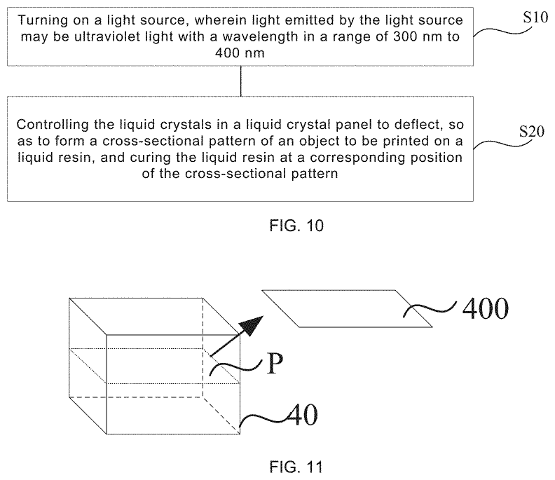

Embodiments of the present disclosure provide a method for 3D printing using the above-mentioned photocurable 3D printing apparatus. Referring to FIG. 10, the method includes 310 to 320.

S10, turning on a light source, wherein light emitted by the light source may be ultraviolet light with a wavelength in a range of 300 nm to 400 nm; and

S20, controlling the liquid crystals in a liquid crystal panel to deflect, so as to form a cross-sectional pattern of an object to be printed on a liquid resin, and curing the liquid resin at a corresponding position of the cross-sectional pattern.

For example, the reversing degree of the liquid crystal molecules in each sub-pixel may be controlled by turning on and off a thin-film transistor in each sub-pixel region, thereby controlling a luminous flux and forming a cross-sectional pattern of the object to be printed. By curing the liquid resin at the corresponding position of the cross-sectional pattern, a layer may be formed. After irradiation and curing layer by layer, a 3D model may be formed by stacking finally.

The method for 3D printing provided by the embodiments of the present disclosure has the same beneficial technical effects as the 3D printing apparatus described above, which will not be repeated here.

The forgoing descriptions are merely specific implementations of the present disclosure, but the protection scope of the present disclosure is not limited thereto. Any changes or replacements that a person skilled in the art could conceive of within the technical scope of the present disclosure shall be included in the protection scope of the present disclosure. Therefore, the protection scope of the present disclosure shall be subject to the protection scope of the claims.

1. An opposite substrate, comprising:
a base substrate;
a black matrix disposed on a side of the base substrate, the black matrix defining a plurality of opening regions; and
a phase shift film disposed on the side of the base substrate, the phase shift film including at least one first portion, and at least one of the opening regions is provided with a first portion therein; the first portion being frame-shaped, and an outer border of the first portion coinciding with a border of an opening region; the phase shift film being configured to reverse a phase of a light wave passing through itself.

2. The opposite substrate according to claim 1, wherein a distance between an outer side and its opposite inner side of the first portion of the phase shift film in a direction perpendicular to the outer side equal to a distance between another outer side and its opposite inner side in a direction perpendicular to the other outer side.

3. The opposite substrate according to claim 2, wherein the distance between the outer side and its opposite inner side of the first portion of the phase shift film in the direction perpendicular to the outer side is within a range of 0.4 μm to 0.5 μm.

4. The opposite substrate according to claim 1, wherein the phase shift film further includes a second portion;
the second portion covers a side of the black matrix away from the base substrate;
the second portion and the first portion are continuous and are an integrative structure; and
an orthographic projection of the second portion on the base substrate and an orthographic projection of the black matrix on the base substrate at least partially overlap.

5. The opposite substrate according to claim 4, wherein first portions of the phase shift film located in two adjacent opening regions and the second portion of the phase shift film covering a portion of the black matrix between the two adjacent opening regions are continuous and are an integrative structure.

6. The opposite substrate according to claim 1, wherein a material of the black matrix includes chromium.

7. The opposite substrate according to claim 1, further comprising:
an encapsulation layer disposed on a side of the black matrix and the phase shift film away from the base substrate.

8. The opposite substrate according to claim 7, wherein a material of the encapsulation layer includes a transparent resin.

9. A liquid crystal panel, comprising:
an array substrate;
an opposite substrate opposite to the array substrate; the opposite substrate being the opposite substrate according to claim 1, and an opening region in the opposite substrate being directly opposite to a sub-pixel of the liquid crystal panel; and
a liquid crystal layer disposed between the array substrate and the opposite substrate.

10. The liquid crystal panel according to claim 9, further comprising:
a first polarizer disposed on a side of the array substrate away from the opposite substrate; and
a second polarizer disposed on a side of the opposite substrate away from the array substrate.

11. A 3D printing apparatus, comprising:
the liquid crystal panel according to claim 9; and
a light source disposed at a side of the array substrate of the liquid crystal panel away from the opposite substrate;
wherein the liquid crystal panel is configured to control a luminous flux of light emitted by the light source according to a cross-sectional pattern of an object to be printed, so as to display the cross-sectional pattern of the object to be printed.

12. The 3D printing apparatus according to claim 11, wherein the light emitted by the light source is ultraviolet light with a wavelength in a range of 300 nm to 400 nm.

13. A method for manufacturing the opposite substrate according to claim 1, the method comprising:
providing the base substrate;
forming the black matrix on the side of the base substrate, the black matrix defining the plurality of opening regions; and
forming the phase shift film on the side of the base substrate, the phase shift film including the at least one first portion, and the at least one of the opening regions is provided with the first portion therein; the first portion being frame-shaped, and the outer border of the first portion coinciding with the border of the opening region; the phase shift film being configured to reverse the phase of the light wave passing through itself.

14. The method according to claim 13, wherein a distance between an outer side and its opposite inner side of the first portion of the phase shift film in a direction perpendicular to the inner side is equal to a distance between another outer side and its opposite inner side in a direction perpendicular to the inner side.

15. The method according to claim 14, wherein a distance between an outer side and its opposite inner side of the first portion of the phase shift film in a direction perpendicular to the inner side is within a range of 0.4 μm to 0.5 μm.

16. The method according to claim 13, wherein forming the phase shift film on the side of the base substrate further includes:
forming the phase shift film including a second portion;
the second portion covers a side of the black matrix away from the base substrate;
the second portion and the first portion are continuous and are an integrative structure; and
an orthographic projection of the second portion on the base substrate and an orthographic projection of the black matrix on the base substrate at least partially overlap.

17. The method according to claim 16, wherein first portions of the phase shift film located in two adjacent opening regions and a portion of the second portion of the phase shift film covering a portion of the black matrix between the two adjacent opening regions are continuous and are an integrative structure.

18. The method according to claim 13, further comprising:
forming an encapsulation layer on a side of the black matrix and the phase shift film away from the base substrate.
